(19) United States
(12) Patent Application Publication
(10) Pub. No.: US 2023/0237574 A1
(43) Pub. Date: Jul. 27, 2023

(54) COMPUTER-IMPLEMENTED METHOD FOR CALCULATING TRADE PRICE REFERENCE INDICATOR

(71) Applicant: SUN SUN CHAN, Hong Kong (CN)

(72) Inventor: SUN SUN CHAN, Hong Kong (CN)

(21) Appl. No.: 17/908,370

(22) PCT Filed: Jan. 14, 2022
(86) PCT No.: PCT/CN2022/071971

§ 371 Date: Aug. 31, 2022

(30) Foreign Application Priority Data
May 26, 2021 (CN) 202110578948.5

(51) Int. Cl. G06Q 40/04; G06Q 30/0201

(52) U.S. Cl. CPC G06Q 40/04; G06Q 30/0206

(57) ABSTRACT

A computer-implemented method for calculating a trade price reference indicator includes step 101: creating a frequency distribution chart based on a price increment; step 102: selecting an accumulation distribution point from the frequency distribution chart; and step 103: calculating an average deviation of an active range based on the accumulation distribution point, calculating a significant range, and using the significant range as an equitable value of a market. The method calculates and generates a trading reference price indicator of a financial market product by superimposing discrete quantitative elements of time and quantity distributions onto conventional price-time, so as to accurately reflect real-time market transactions, avoid price manipulation, and achieve accurate statistics and analysis of financial prices.

### CROSS REFERENCE TO THE RELATED APPLICATIONS

This application is the national phase entry of International Application No. PCT/CN2022/071971, filed on Jan. 14, 2022, which is based on and claims priority to Chinese patent application No. 202110578948.5, filed on May 26, 2021, the entire contents of which are incorporated herein by reference.

### TECHNICAL FIELD

The present disclosure relates to a computer-implemented method for calculating a trade price reference indicator. The method calculates and generates a trading reference price indicator of a financial market product by superimposing discrete quantitative elements of time and quantity distributions onto conventional price-time.

### BACKGROUND

For each financial product (such as foreign exchange, stock market, bonds, asset transactions, and mergers and acquisitions) and commodities (such as agricultural products and petroleum), many other activities and phenomena occur between the market opening and the market closing and between a peak and a trough. Such activities and phenomena are very useful for monitoring overall market conditions. For example, useful intra-market information includes: a region in which the market is active, a quote corresponding to a largest volume, and a market reaction to a quote coming near a high price or a low price, which is acknowledged and widely used. Although traders and strategy-making analysts do not see these intra-market information from regular data and charts, the information is still widely used. Consequently, a current market usage is: an average price of closing prices of the market in a past period is used as a trade price of the market to conduct various commercial transactions.

There are two problems in the conventional pricing logic of the trade price:

1. The price is prone to be manipulated. Because the average of the closing prices in a period is used as the trade price, but the closing prices may be artificially raised or lowered at the moment just before closing, the trade price is deliberately controlled.

2. The pricing logic is unable to reflect the real situation of market transactions. The real price in the market is not the closing price, but is the trade price for the largest volume or the longest time.

### SUMMARY

To solve the foregoing problem, a primary objective of the present disclosure is to provide a computer-implemented method for calculating a trade price reference indicator. The method calculates and generates a trading reference price indicator of a financial market product by superimposing discrete quantitative elements of time and quantity distributions onto conventional price-time, so as to accurately reflect real-time market transactions, avoid price manipulation, and achieve accurate statistics and analysis of financial prices.

Another objective of the present disclosure is to provide a computer-implemented method for calculating a trade price reference indicator. The method superimposes conventional price-time on discrete quantitative elements of intra-market activities related to time/quantity distributions on different prices, so as to extend the conventional price-time pricing mode.

To achieve the foregoing objectives, the technical solutions of the present disclosure are as follows:

A computer-implemented method for calculating a trade price reference indicator is disclosed. The method includes the following steps:

101. Create a frequency distribution chart based on a price increment, in which a Y-axis represents a discrete price level and an X-axis represents a volume corresponding to each price on the Y-axis.

102. Select an accumulation distribution point from the frequency distribution chart, wherein the accumulation distribution point is a point having a largest number of BTUs, wherein the BTUs are basic time units, and the accumulation distribution point is a price point at which a product is traded for a largest volume.

Therefore, the price point is a price at which the product is traded for the most time or the largest volume and is called an accumulation distribution point.

The accumulation distribution point is generated by way of time or quantity. Therefore, a group of accumulation distribution points are generated by way of time and by way of quantity separately. The group of accumulation distribution points generated by way of time may be different from those generated by way of quantity. The user decides whether the displayed accumulation distribution point is calculated by way of time or by way of quantity. It needs to be noted that under normal circumstances, the accumulation distribution point calculated by way of time is approximate to the accumulation distribution point calculated by way of quantity. That is because a price at which a product is traded for a longer time is naturally a price at which the product is traded for a larger volume.

103. Calculate an average deviation of an active range based on the accumulation distribution point, calculate a significant range, and use the significant range as an equitable value of a market. A corresponding continuous price range that includes continuous trade activities is found, which is called the significant range, to determine the equitable value.

In the present disclosure, a mean shift of the significant range is calculated by using frequency distribution. Each trade interval represents a frequency unit (time or volume) of a price. Therefore, the frequency distribution chart may be deemed a set of transactions and each transaction corresponds to a price. Then, in the present disclosure, an average and a standard deviation of the prices in a trade interval on the whole are calculated. The significant range of the trade interval accounts for 68% of trading activities. Therefore, the significant range may be deemed an equitable value of the market because the significant range is a price range in which participants agree to trade within the entire trade interval.

In step S101, a distribution table is created first by using time and price and a bar chart is created based on the distribution table. Then, the frequency distribution chart is constructed by use of a volume method based on the bar chart.

Furthermore, in creating the frequency distribution chart, a preferred time frame is an intraday period and a price increment unit is 0.5. The volume at each discrete price in the intraday period is plotted to form a frequency distribution table first, in which volume data comes from specific volumes and is represented by a number of shares. Then the frequency distribution chart is plotted in which the Y-axis represents the discrete price level and the X-axis represents the volume corresponding to each price on the Y-axis.

The volume is a trading volume of a stock or the U.S. dollar. When the volume of a product such as foreign exchange is unavailable, a trading time length is used instead. The trading time length may be a time unit (if the accumulation distribution point is generated by way of time) or a quantity unit (if the accumulation distribution point is generated by way of trading quantity).

The “bar chart”, whether in the form of a bar chart or Japanese candlestick, is used to depict a graphical body within a given time interval in any price-time chart.

In step 103, the significant range is defined as a value of “average±(standard deviation) (constant)”, where the constant is 1 by default; the significant range is calculated by a formula: significant range=μ±δ, where, μ is an average of prices, and is calculated by a formula:

$$μ = \frac{\sum f ( x )}{n} ,$$

where n represents a sum or a number of frequencies, f(x)=price (P)*frequency (F), δ is the standard deviation,

$$δ = \sqrt{\frac{\sum {( f ( x ) - μ )}^{2}}{n}} ;$$

and the significant range is deemed the equitable value of the market.

### Beneficial Effects of the Present Disclosure are as Follows

In the present disclosure, the method calculates and generates a trading reference price indicator of a financial market product by superimposing discrete quantitative elements of time and quantity distributions onto conventional price-time, so as to accurately reflect real-time market transactions, avoid price manipulation, and achieve accurate statistics and analysis of financial prices.

Before the present disclosure, a trader who wants to track quantity and time distribution information has to perform the tracking manually. Furthermore, the information lacks a consistent quantification standard and merely relies on rough estimation. According to the present disclosure, by quantifying the intra-market information and superimposing the information on the chart, the trader no longer needs to observe and memorize the information manually, but can retrieve the information immediately from the chart. In addition, the present disclosure is helpful to analyze the time sequence acts corresponding to the intra-market information and the relationship between the information and ordinary OHLC (open, high, low, and close). Then the present disclosure helps the trader to form new trading insights more easily, and provides the trader with accurate and reliable data.

### BRIEF DESCRIPTION OF THE DRAWINGS

FIG. 1 is a time-price distribution table according to the present disclosure;

FIG. 2 is a time-price bar chart according to the present disclosure;

FIG. 3 is a price-volume frequency table according to the present disclosure;

FIG. 4 is a price-volume frequency distribution chart according to the present disclosure; and

FIG. 5 is significant range calculation table according to the present disclosure.

### DETAILED DESCRIPTION OF THE EMBODIMENTS

To make the objectives, technical solutions, and advantages of the present disclosure clearer, the present disclosure is further described below in detail with reference to the drawings and embodiments. Understandably, the specific embodiments described herein are merely intended to explain the present disclosure but not to limit the present disclosure.

Through research, the applicant finds that in financial and commodity markets, the average closing price is widely used by traders and analysts as a trade price of a financial product or commodity. The practice of using the average closing price as the trade price within a given time interval is widely applicable in the market.

However, for each financial product or commodity, many other activities and phenomena occur between market opening and closing and between a high and a low. Such activities and phenomena are very useful for monitoring overall market conditions. For example, useful intra-market information includes: a region in which the market is active, a price corresponding to a largest volume, and a market reaction to a price coming near a high or a low. It is well known that the intra-market information is widely used although the information is not seen in a regular chart by traders and analysts who formulate trading strategies.

The conventional pricing method that adopts just the average closing price is obviously unable to provide complete information on the basic market conditions. An intermediate path of the price from the opening price to the closing price has been ignored. Conventionally, a trader who wants to keep track of this type of intra-market information has to rely on tedious manual processes; for example, the trader observes price fluctuations on a quote screen, records the information into a log, and deduces such information by analyzing time spent on a price and volume distribution in a bar chart. Additionally, the trader records the time length or volume of trading at a specific price in a time/volume unit in a bar chart by creating a frequency distribution chart, so as to easily discern a price range in which the trading is of a high level of activity, a low level of activity, a major level of activity, and other information. In addition, various statistical parameters can be calculated based on such a distribution. Therefore, by using a system to record trade process data and perform real-time computing, the applicant develops a new type of trade price reference indicator “accumulation distribution indicator” that objectively reflects the real market price.

The following describes how to create a frequency distribution chart.

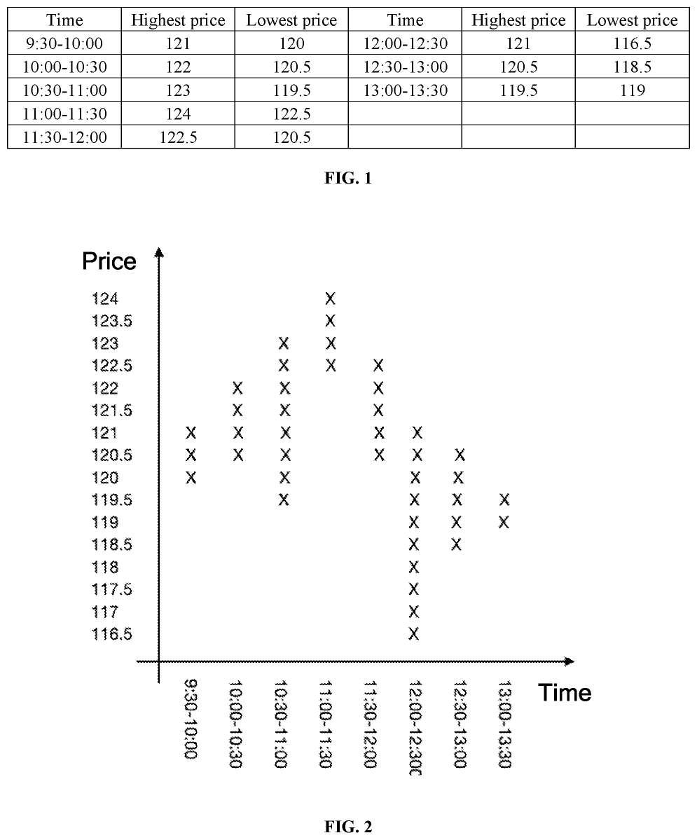

As shown in the table in FIG. 1, a bar table of time and price is created first. As shown in the table, the first row “time” corresponds to 9:30-10:00, the highest price is 121, and the lowest price is 120. In FIG. 2, “X” is marked at the coordinates corresponding to 120, 120.5, and 121. Next, in the second column corresponding to 10:00-10:30, in the second section, the highest price is 122, and the lowest price is 120.5. Therefore, an “X” is marked at each coordinate corresponding to 120.5, 121, 121.5, and 122 separately. It is the same with the remaining data in FIG. 2. For brevity, the remaining data is not described repeatedly herein.

FIG. 2 also shows that the price distribution obtained in the drawing approximates a normal distribution obtained under usual circumstances. Each discrete price level on the Y-axis is correlated with a number of BTUs. The BTUs are a measure of an intraday time length in which the trade occurs at the corresponding price level.

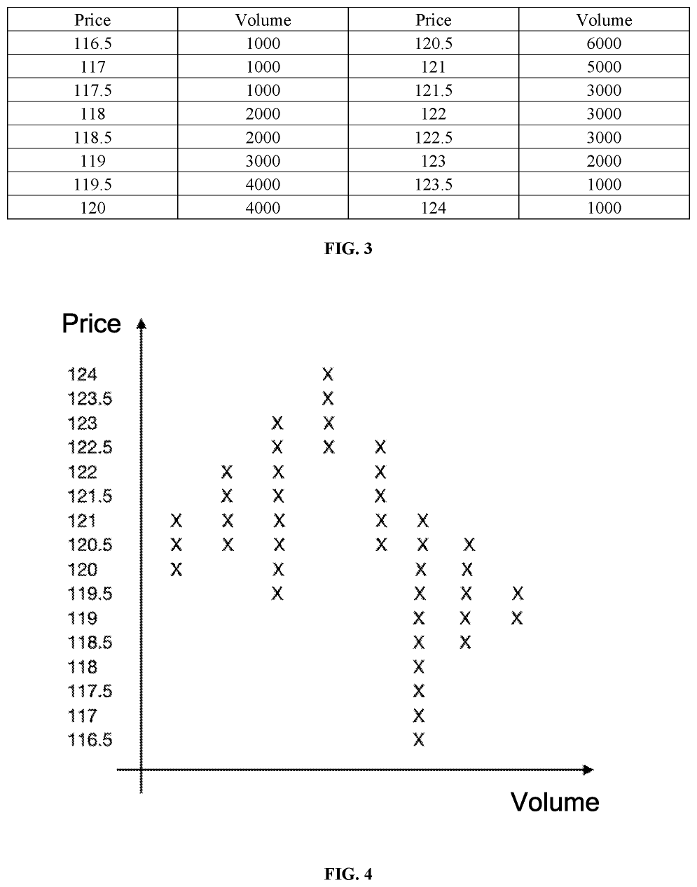

FIG. 3 and FIG. 4 show exemplary embodiments of constructing a frequency distribution chart by way of volume. The preferred time frame is an intraday period and the price increment unit is 0.5. The intraday volume corresponding to each discrete price is shown in the table in FIG. 3. The volume data comes from the trading volume and is denoted by the number of shares. In other embodiments, if the security is a commodity or futures contract, the volume data may be denoted by the dollar amount of the traded share or the number of exchanged contracts. FIG. 4 shows an obtained frequency distribution chart. The Y-axis represents a discrete price level and the X-axis represents a volume corresponding to each price on the Y-axis. In FIG. 4, it is assumed that each “X” represents 1000 shares. According to the table in FIG. 3, the price point 124 corresponds to a volume of 1000. Therefore, in the distribution chart of FIG. 4, an “X” is marked at the price point 124. Similarly, the price point 123 corresponds to a volume of 2000. Therefore, in the distribution chart, two “X” symbols are marked at the price point 123. Other entries in the table are plotted in the same way in the distribution chart. In short, the repeated discussion of remaining entries in the drawing is omitted.

The distribution chart in FIG. 4 is deliberately constructed to be identical to that in FIG. 2 to facilitate subsequent discussion.

A user can discretionarily choose to export the relevant distribution chart from a chart program, whether by way of time or by way of volume. For fully liquid securities such as currency and index futures, a chart exported by way of time is highly correlated with a chart exported by way of volume. That is because, under the same conditions, a price at which a product is traded for a longer time is naturally a price at which the product is traded for a larger volume. However, the circumstance may be different for illiquid securities such as small-cap stocks. Inactive stocks sometimes stay at the same price for most of the day with little or no volume. In this case, a chart exported by way of time may give wrong result. On the other hand, for liquid securities, the chart is preferably exported by way of time because real-time volumes of actively traded securities may be imprecise. The user needs to decide which method is applied to each different security.

The following describes how to determine an accumulation distribution indicator.

Considering a frequency distribution chart shown in FIG. 2. As shown in FIG. 2, the price point 120.5 corresponds to the largest number of BTUs. The frequency distribution chart may adopt a time unit (if the chart is plotted by way of time) or a volume unit (if the chart is plotted by way of volume). Therefore, the price point is a price at which the product is traded for the most time or the largest volume. The price point 120.5 is called an accumulation distribution point.

Sometimes, the price level and the largest number of BTUs at which the product is traded may correspond to a plurality of accumulation distribution points. In this case, the chart program displays an accumulation distribution point closest to a midpoint of a preferred bar by default. Such an accumulation distribution point is called a central accumulation distribution point. Alternatively, the chart program may also be configured to display all the accumulation distribution points on a single bar to the user.

The accumulation distribution chart is plotted by way of time or volume. Therefore, a group of accumulation distribution points are generated by way of time and by way of volume separately. The group of accumulation distribution points generated by way of time are different from those generated by way of volume. The user decides whether the displayed accumulation distribution point is calculated by way of time or by way of volume. It needs to be noted that under normal circumstances, the accumulation distribution point calculated by way of time is approximate to the accumulation distribution point calculated by way volume. That is because a price at which a product is traded for a longer time is naturally a price at which the product is traded for a larger volume.

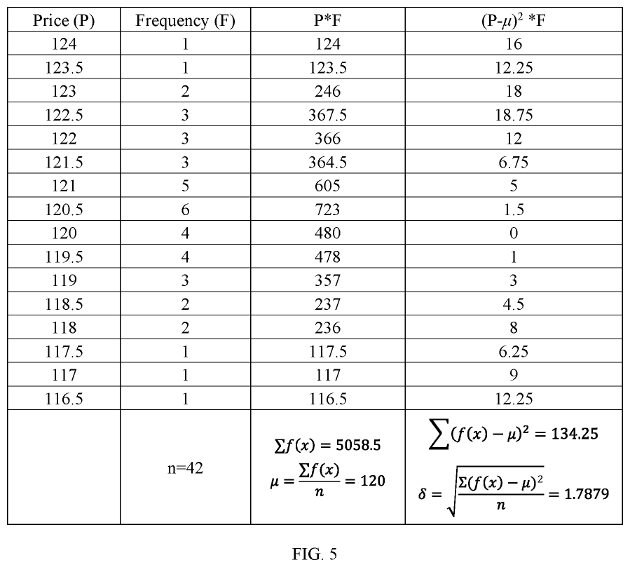

A mean deviation of the active range is calculated by using the frequency distribution chart in FIG. 2 as an example. In the drawing, each BTU represents a frequency unit (whether time or volume) of a specified price. Therefore, the frequency distribution chart may be deemed a set of BTUs on the whole and each BTU corresponds to a price. Then, in the present disclosure, an average and a standard deviation of the BTU prices on the whole are calculated. Then the significant range is defined as a value of “average±(standard deviation) (constant)”, where the constant is 1 by default. Therefore, by default, the active interval represents a price interval in the bar chart and includes approximately 68% (standard deviation) of all trade activities, whether by time or volume. The system reads the value of the constant from the parameter file in FIG. 1. In FIG. 5, it is assumed that the constant is 1. Therefore, the significant range is equal to μ±δ, and equal to (121.79, 118.21). The significant range of the active interval accounts for 68% of trading activities. Therefore, the significant range may be deemed an equitable value of the market because the significant range is a price range in which participants agree to trade within the entire trade interval.

In summary, in the present disclosure, the method calculates and generates a trading reference price indicator of a financial market product by superimposing discrete quantitative elements of time and quantity distributions onto conventional price-time, so as to accurately reflect real-time market transactions, avoid price manipulation, and achieve accurate statistics and analysis of financial prices.

According to the present disclosure, by quantifying the intra-market information and superimposing the information on the chart, the trader no longer needs to observe and memorize the information manually, but can retrieve the information immediately from the chart. In addition, the present disclosure is helpful to analyze the time sequence acts corresponding to the intra-market information, and the relationship between the information and ordinary OHLC (open, high, low, and close). Then the present disclosure helps the trader to form new trading insights more easily, and provides the trader with accurate and reliable data.

What is described above is merely exemplary embodiments of the present disclosure, but not intended to limit the present disclosure. Any modifications, equivalent substitutions, improvements and the like made without departing from the spirit and principles of the present disclosure fall within the protection scope of the present disclosure.

What is claimed is:

1. A computer-implemented method for calculating a trade price reference indicator, comprising the following steps:
101: creating a frequency distribution chart based on a price increment, wherein a Y-axis represents a discrete price level and an X-axis represents a volume corresponding to each price on the Y-axis;
102: selecting an accumulation distribution point from the frequency distribution chart, wherein the accumulation distribution point is a price point at which a product is traded for a largest volume or for a largest number of basic time units (BTUs); and
103: calculating an average deviation of an active range based on the accumulation distribution point, calculating a significant range, and using the significant range as an equitable value of a market, wherein a corresponding continuous price range comprising continuous trade activities is found to determine the equitable value, wherein the corresponding continuous price range is called the significant range.

2. The computer-implemented method according to claim 1, wherein in step 101, a distribution table is created first by using time and price, and a bar chart is created based on the distribution table; and then the frequency distribution chart is constructed by using a volume method based on the bar chart.

3. The computer-implemented method indicator according to claim 2, wherein when the frequency distribution chart is created, a preferred time frame is an intraday period, and a price increment unit is 0.5; a volume at each discrete price in the intraday period is plotted to form a frequency distribution table first, wherein volume data comes from specific volumes and is represented by a number of shares; and then the frequency distribution chart is plotted with the Y-axis representing the discrete price level and the X-axis representing the volume corresponding to each price on the Y-axis.

4. The computer-implemented method according to claim 1, wherein in step 103, the significant range is defined as a value of “average±(standard deviation)(constant)”, wherein the constant is 1 by default; the significant range is calculated by a formula: significant range=μ±δ, wherein, μ is an average of prices, and is calculated by a formula:
$$μ = \frac{\sum f ( x )}{n} ,$$
wherein n represents a sum of a number of frequencies, f(x)=price (P)*frequency (F), δ is the standard deviation,
$$δ = \sqrt{\frac{\sum {( f ( x ) - μ )}^{2}}{n}} ;$$
and the significant range is deemed the equitable value of the market.
